(19) United States
(12) Patent Application Publication
(10) Pub. No.: US 2022/0261577 A1
(43) Pub. Date: Aug. 18, 2022

(54) METHOD AND APPARATUS FOR REIDENTIFICATION

(71) Applicant: ELECTRONICS AND TELECOMMUNICATIONS RESEARCH INSTITUTE, Daejeon (KR)

(72) Inventors: Seung Woo NAM, Daejeon (KR); Jang Woon BAEK, Daejeon (KR); Joon-Goo LEE, Daejeon (KR); Kil Taek LIM, Daejeon (KR); Byung Gil HAN, Daejeon (KR)

(21) Appl. No.: 17/518,411

(22) Filed: Nov. 3, 2021

(30) Foreign Application Priority Data
Feb. 17, 2021 (KR) 10-2021-0020920

(51) Int. Cl. G06K 9/00; G06K 9/20; G06T 7/292; G06N 20/00

(52) U.S. Cl. CPC G06K 9/00664; G06N 20/00; G06T 7/292; G06K 9/2054

(57) ABSTRACT

A re-identification apparatus acquires a first image in which a tracking target entering an intersection is captured, and identifies the tracking target and targets having a predetermined positional relationship with the tracking target in the first image. The re-identification apparatus selects a camera to be used for re-identification of the tracking target based on a signal system of the intersection, and acquires a second image captured by the selected camera and one or more third images before or after the second image. The re-identification apparatus determines a target identified in the second image and the third images among the targets when identifying an object corresponding to the tracking target in the second image, and determines whether the re-identification of the tracking target is successful based on the targets identified in the first image and the target identified in the second image and the third images.

### CROSS-REFERENCE TO RELATED APPLICATION

This application claims priority to and the benefit of Korean Patent Application No. 10-2021-0020920 filed in the Korean Intellectual Property Office on Feb. 17, 2021, the entire contents of which are incorporated herein by reference.

### BACKGROUND

### (a) Field

The described technology relates to a method and apparatus for re-identification.

### (b) Description of the Related Art

In order to track a travel route of a vehicle or pedestrian, re-identification is performed on images acquired by using cameras (e.g., closed-circuit televisions, CCTVs) on the road. When tracking the travel route of the vehicle or pedestrian on the road by using the existing vehicle re-identification technology or pedestrian re-identification technology, accuracy may be deteriorated. In particular, there are many similar vehicle models and vehicles with similar colors, so the accuracy may be greatly deteriorated.

Further, since it is necessary to compare a target image with all gallery images acquired from the CCTVs for re-identification within an area where the travel route is to be tracked, it may take a lot of time due to a large amount of data to be compared.

### SUMMARY

Some embodiments may provide a re-identification method and apparatus for accurately identifying a tracking target.

According to an embodiment, a re-identification apparatus including a memory configured to store one or more instructions and a processor configured to execute the one or more instructions may be provided. The processor, by executing the one or more instructions, may acquire a first image in which a tracking target entering an intersection is captured, identify the tracking target and a plurality of targets having a predetermined positional relationship with the tracking target in the first image, select a camera to be used for re-identification of the tracking target from among a plurality of cameras installed at the intersection based on a signal system of the intersection, acquire a second image captured by the selected camera and one or more third images before or after the second image, determine one or more targets identified in the second image and the one or more third images among the plurality of targets, in response to identifying an object corresponding to the tracking target in the second image, and determine whether the re-identification of the tracking target is successful based on the plurality of targets identified in the first image and the target identified in the second image and the one or more third images.

In some embodiments, the processor may determine a re-identification score based on a number of the plurality of targets identified in the first image and a number of targets identified in the second image and the one or more third images, and determine that the re-identification of the tracking target is successful in response to the identification score exceeding a threshold.

In some embodiments, the processor may determine the re-identification score based on a ratio of the number of targets identified in the second image and the one or more third image to the number of the plurality of targets identified in the first image.

In some embodiments, the threshold may be determined by machine learning.

In some embodiments, the predetermined positional relationship may include at least one of a front side of the tracking target, a rear side of the tracking target, a left side of the tracking target, or a right side of the tracking target.

In some embodiments, the processor may select, as the camera to be used for the re-identification of the tracking target, a camera for capturing a road on which the tracking target can move from the intersection at a current traffic signal of the intersection from among the plurality of cameras.

In some embodiments, in response to the re-identification of the tracking target being failed, the processor may select another camera from among the plurality of cameras based on the signal system.

In some embodiments, the processor may acquire a plurality of road images in which a plurality of roads included in the intersection are respectively captured, and determine the signal system of the intersection based on road information including vehicle movement information in each of the road images.

In some embodiments, the road information may further include pedestrian movement information in a crosswalk when the crosswalk exists in each of the road images.

According to another embodiment, a re-identification method of a tracking target performed by a computing device is provided. The re-identification method includes acquiring a first image in which the tracking target entering an intersection is captured, identifying the tracking target and a plurality of targets having a predetermined positional relationship with the tracking target in the first image, acquiring one or more second images captured by one or more cameras among a plurality of cameras installed at the intersection; determining a target identified in the one or more second images among the plurality of targets in response to identifying the tracking target in the one or more second images, and determining whether re-identification of the tracking target is successful based on the plurality of targets identified in the first image and the target identified in the one or more second images.

In some embodiments, the one or more second images may include an image in which the tracking target is identified and an image before or after the image in which the tracking target is identified.

In some embodiments, the re-identification method may further include selecting the one or more cameras from among the plurality of cameras based on a signal system of the intersection.

In some embodiments, selecting the one or more cameras may include selecting a camera for capturing a road on which the tracking target can move from the intersection at a current traffic signal of the intersection from among the plurality of cameras.

In some embodiments, the re-identification method may further include selecting another camera from among the plurality of cameras based on the signal system in response to the re-identification of the tracking target being failed.

In some embodiments, determining whether the re-identification of the tracking target is successful may include determining a re-identification score based on a number of the plurality of targets identified in the first image and a number of targets identified in the one or more second images, and determining that the re-identification of the tracking target is successful in response to the identification score exceeding a threshold.

According to yet another embodiment of the present invention, a re-identification method of a tracking target performed by a computing device is provided. The re-identification method includes acquiring a first image in which the tracking target entering an intersection is captured, identifying the tracking target from the first image, selecting a camera to be used for re-identification of the tracking target from among a plurality of cameras installed at the intersection based on a signal system of the intersection, and re-identifying the tracking target from a second image captured by the selected camera.

According to some embodiments, the tracking target may be accurately re-identified. According to some embodiments, a load according to image analysis for the re-identification may be reduced.

### BRIEF DESCRIPTION OF THE DRAWINGS

FIG. 1 is an example block diagram of a traffic signal recognition apparatus according to an embodiment.

FIG. 2 is an example flowchart of a traffic signal recognition method according to an embodiment.

FIG. 3, FIG. 4, FIG. 5, and FIG. 6 are diagrams showing examples of road images used in a traffic signal recognition method according to an embodiment.

FIG. 7 is an example block diagram showing a re-identification apparatus according to an embodiment.

FIG. 8 is an example flowchart showing a re-identification method according to an embodiment.

FIG. 9, FIG. 10, FIG. 11, and FIG. 12 are diagrams showing examples of road images used in a re-identification method according to an embodiment.

FIG. 13 is a diagram showing an example computing device according to an embodiment.

### DETAILED DESCRIPTION OF THE EMBODIMENTS

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

As used herein, the singular forms “a”, “an” and “the” are intended to include the plural forms as well, unless the context clearly indicates otherwise.

The sequence of operations or steps is not limited to the order presented in the claims or figures unless specifically indicated otherwise. The order of operations or steps may be changed, several operations or steps may be merged, a certain operation or step may be divided, and a specific operation or step may not be performed.

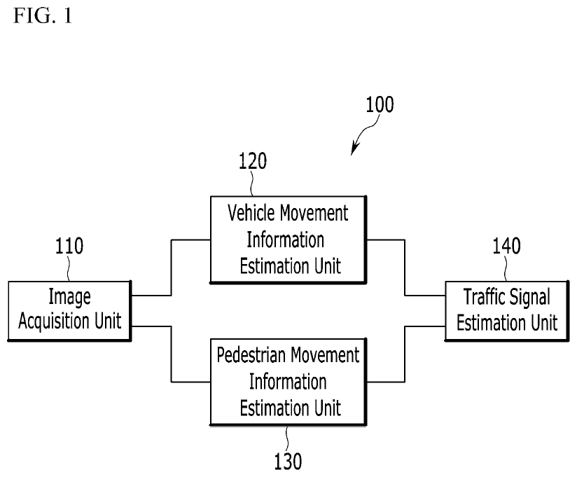

FIG. 1 is an example block diagram of a traffic signal recognition apparatus according to an embodiment.

Referring to FIG. 1, a traffic signal recognition apparatus 100 includes an image acquisition unit 110, a vehicle movement information estimation unit 120, a pedestrian movement information estimation unit 130, and a traffic signal estimation unit 140.

The image acquisition unit 110 acquires a plurality of road images from a camera installed around an intersection that is a target of traffic signal estimation. In some embodiments, the plurality of road images may be acquired from a plurality of cameras, respectively. In some embodiments, at least two images among the plurality of road images may be captured (photographed) by one camera while rotating. In some embodiments, the camera may photograph a specific direction at the intersection to capture (photograph) a vehicle, a crosswalk, or a traffic light located in the specific direction.

The vehicle movement information estimation unit 120 identifies a vehicle from the road image, and estimates movement information of the vehicle based on a moving state or stop state of the vehicle. The movement information may include, for example, a moving direction or the stop state. The pedestrian movement information estimation unit 130 identifies a crosswalk from the road image, and estimates whether a pedestrian moves in the crosswalk.

The traffic signal estimation 140 estimates a traffic signal of the intersection based on the moving direction of the vehicle and whether the pedestrian moves in the crosswalk, and estimates a signal system of the intersection by repeating an operation of estimating the traffic signal.

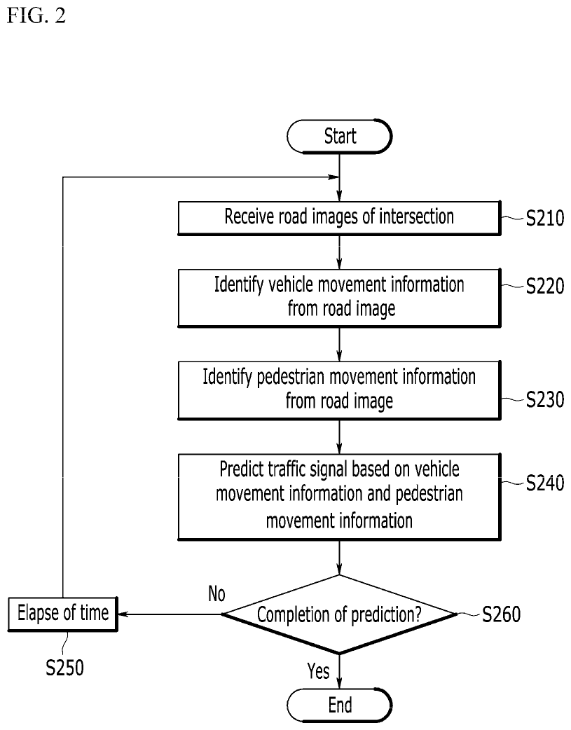

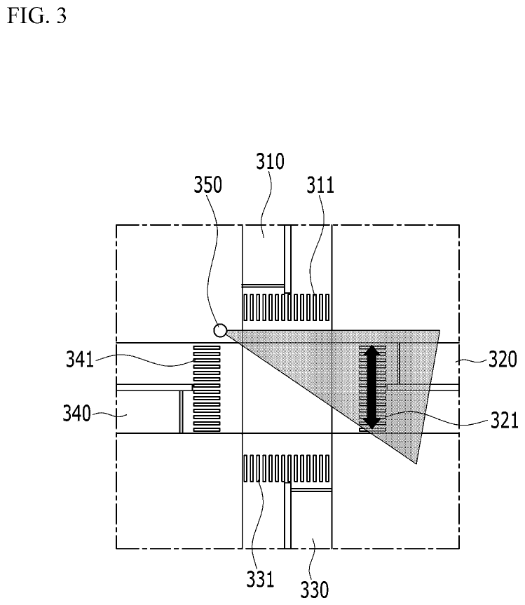

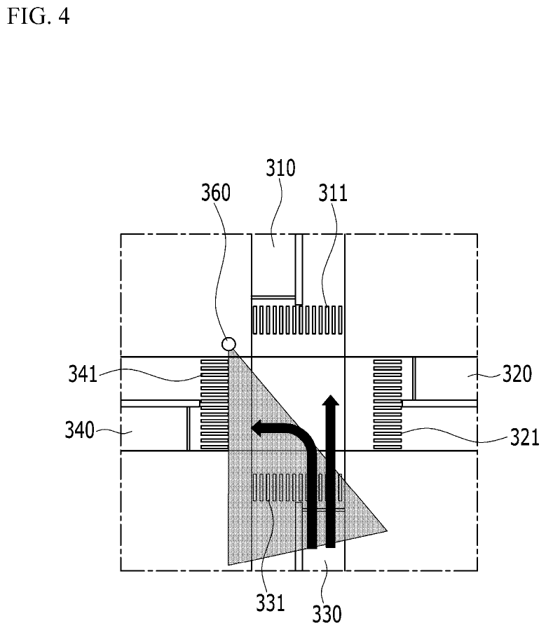

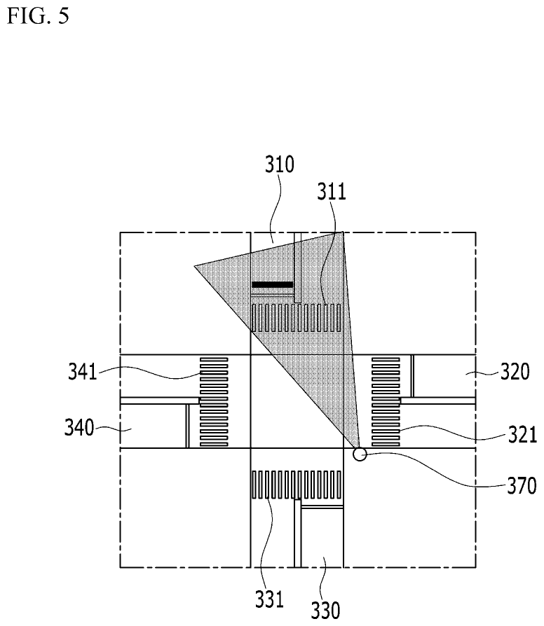

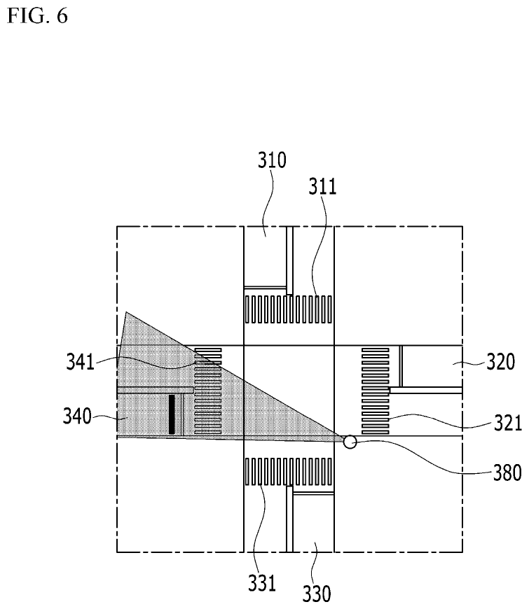

FIG. 2 is an example flowchart of a traffic signal recognition method according to an embodiment. FIG. 3, FIG. 4, FIG. 5, and FIG. 6 are diagrams showing examples of road images used in a traffic signal recognition method according to an embodiment.

It is assumed in FIG. 2 to FIG. 6 that an intersection is a four-way intersection for convenience of description. Further, for convenience of description, it is assumed that an upper end of FIG. 3 to FIG. 6 is north. In this case, the intersection may include a north road 310, an east road 320, a south road 330, and a west road 340. In addition, crosswalks 311, 321, 331, and 341 may be formed on the north road 310, the east road 320, the south road 330, and the west road 340, respectively.

Referring to FIG. 2, in step S210, a traffic signal recognition apparatus receives a plurality of road images included in an intersection captured at a certain time. The plurality of road images may include images of various directions at the intersection. In some embodiments, the plurality of road images may include images of all directions existing at the intersection. For example, in a case of the four-way intersection, it may be provided an image (i.e., an east direction image) acquired by capturing the east road 320 by a camera 350 located at a northwest point as shown in FIG. 3, an image (i.e., a south direction image) acquired by capturing the south road 330 by a camera 350 located at a northwest point as shown in FIG. 4, an image (i.e., a north direction image) acquired by capturing the north road 310 by a camera 370 located at a southeast point as shown in FIG. 5, and an image (i.e., a west direction image) acquired by capturing the west road 340 by a camera 380 located at the southeast point as shown in FIG. 6.

The traffic signal recognition apparatus identifies movement information of a vehicle from each road image at step S220. In some embodiments, the movement information of the vehicle may include a moving direction of the vehicle or a stop state of the vehicle. In some embodiments, the traffic signal recognition apparatus may identify movement information of a pedestrian on a crosswalk from each road image at step S230. In some embodiments, the movement information of the pedestrian may include a movement state of the pedestrian on the crosswalk or a stop state of the pedestrian on the crosswalk.

For example, the traffic signal recognition apparatus may identify information that a pedestrian is moving on a crosswalk 321 of the east road 320 from the east direction image as shown in FIG. 3. Further, the traffic signal recognition apparatus may identify information that vehicles are moving straight ahead in the north direction or turning left in the west direction on the south road 330 from the south direction image as shown in FIG. 4. Furthermore, the traffic signal recognition apparatus may identify information that vehicles are stopped on the north road 310 and the west road 340 from the north direction image and the west direction image as shown in FIG. 5 and FIG. 6.

The traffic signal recognition apparatus predicts a traffic signal at a current time based on road information in step S240. In some embodiments, the road information may include movement information of vehicles. In some embodiments, the road information may further include movement information of pedestrians. In examples shown in FIG. 3 to FIG. 6, the traffic signal recognition apparatus may predict a straight-ahead and left-turn signal on the south road 320.

Next, the traffic signal recognition apparatus receives a plurality of road images captured at a time when a predetermined time has elapsed at steps S250 and S210. Accordingly, the traffic signal recognition apparatus may again predict the traffic signal through operations of steps S220, S230, and S240. In this way, the traffic signal recognition apparatus may predict the traffic signal by receiving the road images for each time slot.

By repeating such a process until all traffic signals (i.e., a signal system) of the intersection are predicted, the traffic signal recognition apparatus predicts the traffic signals at the intersection in step S260. Further, the traffic signal recognition apparatus may predict a time for which the same traffic signal is maintained (i.e., when each traffic signal changes) based on a time when each traffic signal has been predicted.

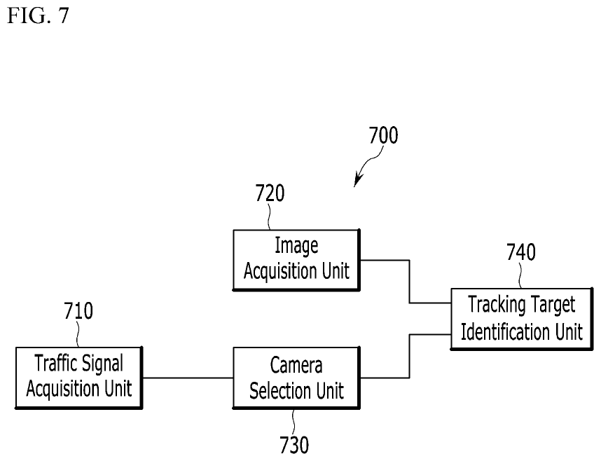

FIG. 7 is an example block diagram showing a re-identification apparatus according to an embodiment.

Referring to FIG. 7, a re-identification apparatus 700 includes a traffic signal acquisition unit 710, an image acquisition unit 720, a camera selection unit 730, and a tracking target identification unit 740.

The traffic signal acquisition unit 710 acquires a signal system of traffic signals at an intersection into which a tracking target (target to be tracked), which is an identification target, enters. In some embodiments, the signal system may be acquired through the above-described method. In some embodiments, the signal system may be acquired through other known methods. In some embodiments, the tracking target may be a vehicle or a person. Hereinafter, for convenience of description, the tracking target is described as the vehicle.

When the tracking target (the tracking vehicle) enters the intersection, the image acquisition unit 720 acquires an image captured by a camera facing the tracking vehicle among cameras installed at the intersection. In this case, the image includes an image of the tracking vehicle and images of a plurality of other vehicles around the tracking vehicle. In some embodiments, the plurality of other vehicles may be vehicles determined based on a positional relationship with the tracking vehicle. For example, the plurality of other vehicles may include vehicles located in front of and behind the tracking vehicle. The plurality of other vehicles may further include a vehicle positioned next to the tracking vehicle.

Next, the camera selection unit 730 selects a camera for performing next capturing based on the signal system of the intersection. The tracking target identification unit 740 receives an image captured by the selected camera from the image acquisition unit 720 and re-identifies the tracking vehicle from the received image. In some embodiments, the image may include a plurality of consecutive images. In some embodiments, when re-identifying a vehicle corresponding to the tracking vehicle from the image and also identifying a predetermined number or more of vehicles among the plurality of other vehicles existing in the previous image, the tracking target identification unit 740 may determine that the re-identified vehicle is the tracking vehicle. In some embodiments, when the tracking target identification unit 740 fails to re-identify the tracking vehicle, the camera selection unit 730 may select another camera.

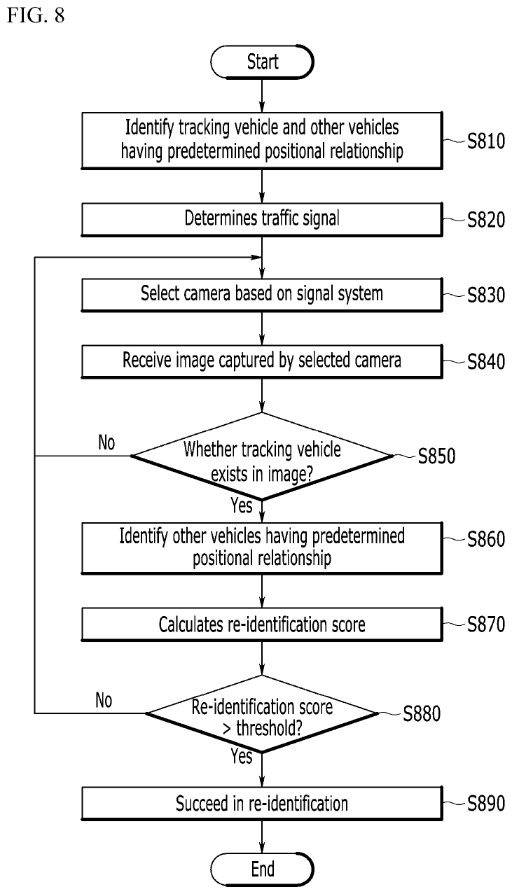

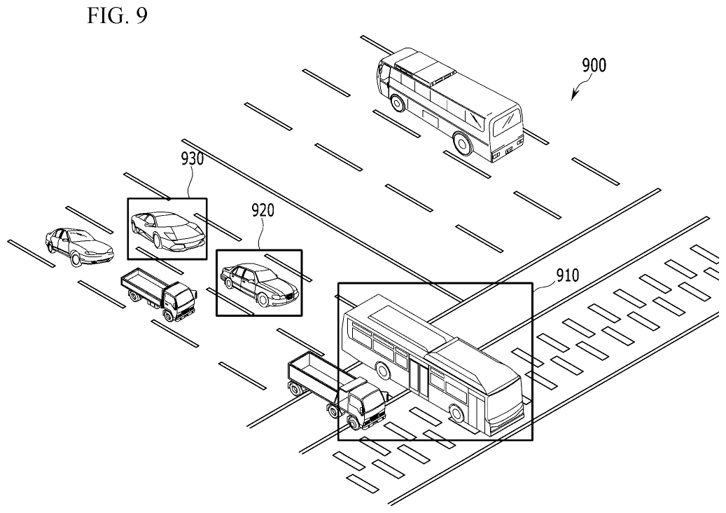

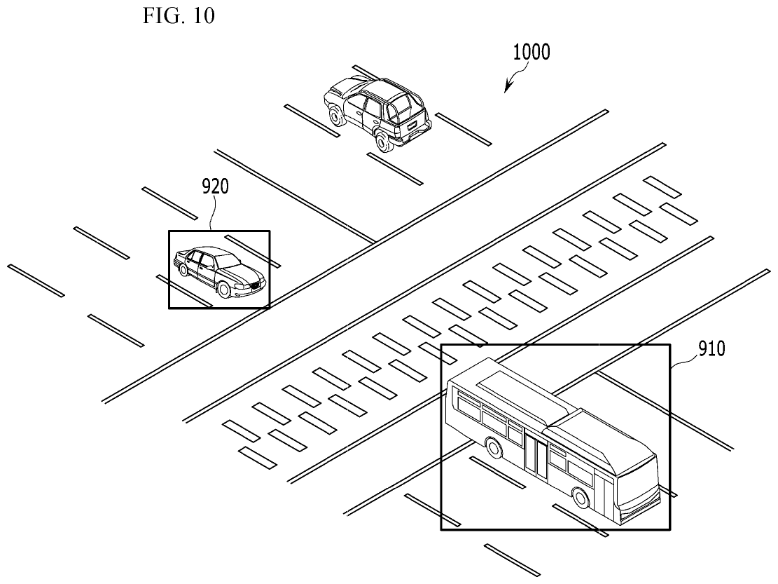

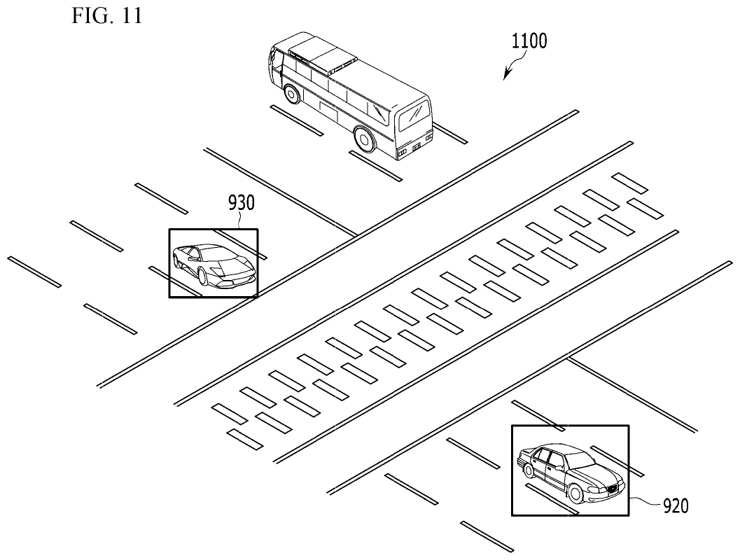

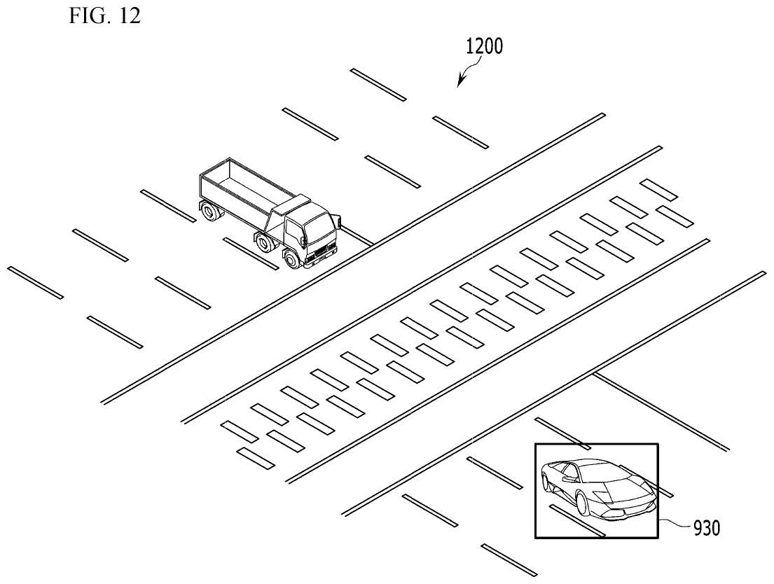

FIG. 8 is an example flowchart showing a re-identification method according to an embodiment. FIG. 9, FIG. 10, FIG. 11, and FIG. 12 are diagrams showing examples of road images used in a re-identification method according to an embodiment.

Referring to FIG. 8, when a tracking vehicle enters an intersection, a re-identification apparatus acquires an image captured by a camera facing the tracking vehicle, and identifies the tracking vehicle and other vehicles having a predetermined positional relationship with the tracking target vehicle from the acquired image at step S810. In some embodiments, the predetermined positional relationship may include at least one positional relationship of a front side of the tracking vehicle, a rear side of the tracking vehicle, a left side of the tracking vehicle, or a right side of the tracking vehicle. For example, in road images shown in FIG. 3 to FIG. 6, when the tracking vehicle enters an intersection from a south road 330, an image captured by a camera 360 may be acquired. In some embodiments, as shown in FIG. 9, the captured image 900 may include a tracking vehicle 910 and a plurality of other vehicles 920 and 930 having a predetermined positional relationship with the tracking vehicle 910. While it has been exemplified in FIG. 9 that the plurality of vehicles 920 and 930 positioned behind the tracking vehicle 910 are as vehicles having the predetermined positional relationship, a vehicle positioned in front of the tracking vehicle 910 or a vehicle positioned next to the tracking vehicle 910 may also be the vehicle having the predetermined positional relationship.

The re-identification apparatus determines a traffic signal corresponding to the tracking vehicle 910 at the intersection in step S820, and selects a camera to capture the tracking vehicle 910 based on the signal system in step S830. In some embodiments, the re-identification apparatus may select the camera that captures a road to which the vehicle can move at a current traffic signal of the intersection.

In some embodiments, when the traffic signal corresponding to the tracking vehicle at the intersection is a straight-ahead and left-turn signal, the re-identification apparatus may select a camera capable of capturing a vehicle passing through the intersection by going straight ahead and a vehicle passing through the intersection by turning left. For example, in the road images shown in FIG. 3 to FIG. 6, cameras 370 and 380 capable of capturing a north road 310 corresponding to the straight-ahead and a west road 340 corresponding to the left-turn may be selected. In some embodiments, when the traffic signal corresponding to the tracking vehicle at the intersection is a straight-ahead signal, the re-identification apparatus may select a camera capable of capturing a vehicle passing through the intersection by going straight ahead. For example, in the road images shown in FIG. 3 to FIG. 6, the camera 370 capable of capturing the north road 310 corresponding to the straight-ahead may be selected. In some embodiments, when the traffic signal corresponding to the tracking vehicle at the intersection is a left-turn signal, the re-identification apparatus may select a camera capable of capturing a vehicle passing through the intersection by turning left. For example, in the road images shown in FIG. 3 to FIG. 6, the camera 380 capable of capturing the west road 340 corresponding to the left-turn may be selected. In some embodiments, when the traffic signal corresponding to the tracking vehicle at the intersection is a stop signal, the re-identification apparatus may select a camera capable of capturing a vehicle passing through the intersection by turning right. For example, in the road images shown in FIG. 3 to FIG. 6, a camera 350 capable of capturing an east road 320 corresponding to the right-turn may be selected.

The re-identification apparatus receives an image captured by the selected camera at step S840, and determines whether the tracking vehicle 910 exists in the received image at step S850. When there is an object corresponding to the tracking vehicle 910 in the received image, in step S860, the re-identification apparatus identifies objects corresponding to the vehicles 920 and 920 having the predetermined positional relationship with the tracking vehicle 910 from a plurality of images before and after the received image. For example, as shown in FIG. 10, when there is the object corresponding to the tracking vehicle 910 in the received image 1000, the re-identification apparatus may determine whether the objects corresponding to the other vehicle 920 and 930 exist in the received image 1000 and the plurality of images 1100 and 1200 before and after the received image 1000, as shown in FIG. 10, FIG. 11, and FIG. 12. For example, the object corresponding to another vehicle 920 may exist in the received image 1000 and the next image 1100 as shown in FIG. 10 and FIG. 11, and the object corresponding to another vehicle 930 may exist in the next image 1100 and the image 1200 after the next one as shown in FIG. 11 and FIG. 12.

Next, in step S870, the re-identification apparatus calculates a re-identification score based on the other vehicles 920 and 930 having the predetermined positional relationship with the tracking vehicle 910 and the other vehicle re-identified in step S860. In some embodiments, the re-identification apparatus may calculate the re-identification score based on the number of other vehicles 920 and 930 having the predetermined positional relationship with the tracking vehicle 910 and the number of other vehicles re-identified in step S860. In some embodiments, the re-identification apparatus may calculate a ratio of the number of other vehicles re-identified in step S860 to the number of other vehicles having the predetermined positional relationship identified in step S810 as the re-identification score. When the calculated re-identification score exceeds a threshold in step S880, the re-identification apparatus determines that the re-identification of the tracking vehicle is successful at step S890.

On the other hand, when the tracking vehicle 910 does not exist in the received image at step S850 or the re-identification score is lower than the threshold at step S880, the re-identification apparatus determines that the tracking vehicle 910 is not re-identified through the selected camera, and selects another camera again based on the signal system in step S830. For example, it is assumed in the road images shown in FIG. 3 to FIG. 6 that the camera 350 capable of capturing the east road 320 corresponding to the right turn has been selected since the traffic signal corresponding to the tracking vehicle is a stop signal. In this case, when the re-identification of the tracking vehicle 910 fails, and a signal following the stop signal is a straight-ahead and left-turn signal, the re-identification apparatus may select the camera 370 capable of capturing the north road 310 corresponding to the straight-ahead and the camera 380 capable of capturing the west road 340 again. After selecting another the other camera again at step S830, the re-identification apparatus repeats the operations of steps S840 to S890.

For example, as shown in FIG. 9, in a case where vehicles enter the intersection in the order of the tracking vehicle 910, the other vehicle 920, and the other vehicle 930, if the other vehicle 920 or 930 having the predetermined positional relationship is identified when an object corresponding to the tracking vehicle 910 passing through the intersection is re-identified, a probability that the re-identified object is the tracking vehicle 910 may be high. In contrast, if the other vehicle 920 or 930 having the predetermined positional relationship is not identified when the object corresponding to the tracking vehicle 910 passing through the intersection is re-identified, a probability that the re-identified object is the tracking vehicle 910 may be low. As described above, by setting the re-identification score for determining whether the re-identified object is the tracking vehicle based on the other vehicles having the predetermined positional relationship with the tracking vehicle, the re-identification accuracy of the tracking vehicle may be increased.

Through this process, the re-identification apparatus can accurately re-identify the tracking vehicle. In addition, since the re-identification apparatus only needs to analyze the images of the cameras according to the signal system without the need to analyze the images of all cameras at the intersection for re-identification, the load due to the image analysis can be reduced.

In some embodiments, the threshold used for the re-identification score may be learned and determined by the machine learning model.

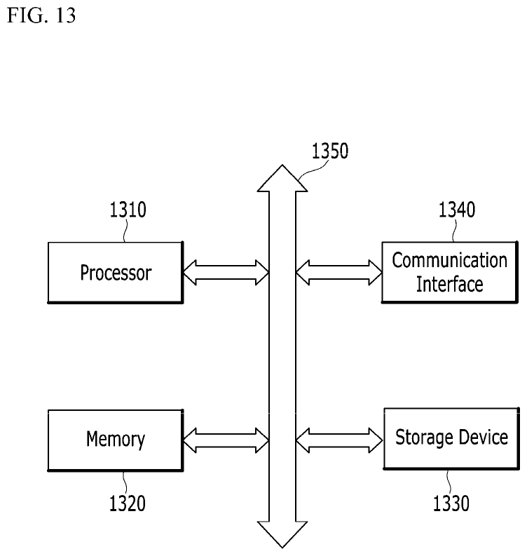

Next, an example computing device capable of implementing a traffic signal recognition apparatus, a traffic signal recognition method, a re-identification apparatus, or a re-identification method according to embodiments is described with reference to FIG. 13.

FIG. 13 is a diagram showing an example computing device according to an embodiment.

Referring to FIG. 13, a computing device includes a processor 1310, a memory 1320, a storage device 1330, a communication interface 1340, and a bus 1350. The computing device may further include other general components.

The processor 1310 controls an overall operation of each component of the computing device. The processor 1310 may be implemented with at least one of various processing units such as a central processing unit (CPU), a microprocessor unit (MPU), a micro controller unit (MCU), and a graphic processing unit (GPU), or may be implemented with a parallel processing unit. Further, the processor 1310 may perform operations on a program for executing the method or functions of the apparatus described above.

The memory 1320 stores various data, instructions, and/or information. The memory 1320 may load a computer program from the storage device 1330 to execute the above-described method or functions of the apparatus. The storage device 1330 may non-temporarily store the program. The storage device 1330 may be implemented as a non-volatile memory.

The communication interface 1340 supports wireless communication of the computing device.

The bus 1350 provides a communication function between components of the computing device. The bus 1350 may be implemented as various types of buses such as an address bus, a data bus, and a control bus.

The computer program may include instructions that cause the processor 1310 to perform the above-described method or functions of the apparatus when loaded into the memory 1320. That is, the processor 1110 may perform the above-described method or functions of the apparatus by executing the instructions.

The above-described method or functions of the apparatus may be implemented as a computer-readable program on a computer-readable medium. In some embodiments, the computer-readable medium may include a removable recording medium or a fixed recording medium. In some embodiments, the computer-readable program recorded on the computer-readable medium may be transmitted to another computing device via a network such as the Internet and installed in another computing device, so that the computer program can be executed by another computing device.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A re-identification apparatus comprising:
a memory configured to store one or more instructions; and
a processor configured to, by executing the one or more instructions:
acquire a first image in which a tracking target entering an intersection is captured;
identify the tracking target and a plurality of targets having a predetermined positional relationship with the tracking target in the first image;
select a camera to be used for re-identification of the tracking target from among a plurality of cameras installed at the intersection based on a signal system of the intersection;
acquire a second image captured by the selected camera and one or more third images before or after the second image;
determine a target identified in the second image and the one or more third images among the plurality of targets, in response to identifying an object corresponding to the tracking target in the second image; and
determine whether the re-identification of the tracking target is successful based on the plurality of targets identified in the first image and the target identified in the second image and the one or more third images.

2. The re-identification apparatus of claim 1, wherein the processor is configured to:
determine a re-identification score based on a number of the plurality of targets identified in the first image and a number of targets identified in the second image and the one or more third images; and
determine that the re-identification of the tracking target is successful in response to the identification score exceeding a threshold.

3. The re-identification apparatus of claim 2, wherein the processor is configured to determine the re-identification score based on a ratio of the number of targets identified in the second image and the one or more third image to the number of the plurality of targets identified in the first image.

4. The re-identification apparatus of claim 2, wherein the threshold is determined by machine learning.

5. The re-identification apparatus of claim 1, wherein the predetermined positional relationship includes at least one of a front side of the tracking target, a rear side of the tracking target, a left side of the tracking target, or a right side of the tracking target.

6. The re-identification apparatus of claim 1, wherein the processor is configured to select, as the camera to be used for the re-identification of the tracking target, a camera for capturing a road on which the tracking target can move from the intersection at a current traffic signal of the intersection from among the plurality of cameras.

7. The re-identification apparatus of claim 1, wherein the processor is configured to select another camera from among the plurality of cameras based on the signal system, in response to the re-identification of the tracking target being failed.

8. The re-identification apparatus of claim 1, wherein the processor is configured to:
acquire a plurality of road images in which a plurality of roads included in the intersection are respectively captured; and
determine the signal system of the intersection based on road information including vehicle movement information in each of the road images.

9. The re-identification apparatus of claim 8, wherein the road information further includes pedestrian movement information in a crosswalk when the crosswalk exists in each of the road images.

10. A re-identification method of a tracking target performed by a computing device, the re-identification method comprising:
acquiring a first image in which the tracking target entering an intersection is captured;
identifying the tracking target and a plurality of targets having a predetermined positional relationship with the tracking target in the first image;
acquiring one or more second images captured by one or more cameras among a plurality of cameras installed at the intersection;
determining a target identified in the one or more second images among the plurality of targets in response to identifying the tracking target in the one or more second images; and
determining whether re-identification of the tracking target is successful based on the plurality of targets identified in the first image and the target identified in the one or more second images.

11. The re-identification method of claim 10, wherein the one or more second images include an image in which the tracking target is identified and an image before or after the image in which the tracking target is identified.

12. The re-identification method of claim 10, further comprising selecting the one or more cameras from among the plurality of cameras based on a signal system of the intersection.

13. The re-identification method of claim 12, wherein selecting the one or more cameras comprises selecting a camera for capturing a road on which the tracking target can move from the intersection at a current traffic signal of the intersection from among the plurality of cameras.

14. The re-identification method of claim 12, further comprising selecting another camera from among the plurality of cameras based on the signal system in response to the re-identification of the tracking target being failed.

15. The re-identification method of claim 10, wherein determining whether the re-identification of the tracking target is successful comprises:
determining a re-identification score based on a number of the plurality of targets identified in the first image and a number of targets identified in the one or more second images; and
determining that the re-identification of the tracking target is successful in response to the identification score exceeding a threshold.

16. A re-identification method of a tracking target performed by a computing device, the re-identification method comprising:
acquiring a first image in which the tracking target entering an intersection is captured;
identifying the tracking target from the first image;
selecting a camera to be used for re-identification of the tracking target from among a plurality of cameras installed at the intersection based on a signal system of the intersection; and
re-identifying the tracking target from a second image captured by the selected camera.
